(19) United States
(12) Patent Application Publication
(10) Pub. No.: US 2018/0115200 A1
(43) Pub. Date: Apr. 26, 2018

(54) BRUSHLESS MOTOR

(71) Applicant: AISIN SEIKI KABUSHIKI KAISHA, Kariya-shi (JP)

(72) Inventors: Akihiro YASUI, Kariya-shi (JP); Nobuyasu MIWA, Ichinomiya-shi (JP); Takemitsu SUMIYA, Kariya-shi (JP); Eisuke UMEMURA, Kasugai-shi (JP)

(73) Assignee: AISIN SEIKI KABUSHIKI KAISHA, Kariya-shi (JP)

(21) Appl. No.: 15/703,334

(22) Filed: Sep. 13, 2017

(30) Foreign Application Priority Data
Oct. 20, 2016 (JP) 2016-206203

(51) Int. Cl. H02K 1/14; H02K 1/27; H02K 3/12; H02K 3/28; H02K 21/16

(52) U.S. Cl. CPC H02K 1/146; H02K 1/2753; H02K 2201/03; H02K 3/28; H02K 21/16; H02K 3/12

(57) ABSTRACT

A brushless motor includes: a magnet rotor rotatable integrally with a rotary shaft; and a stator disposed to face the magnet rotor with a gap therebetween in a diameter direction of the magnet rotor, The stator includes first teeth each having a first counter surface facing the magnet rotor with a first air gap therebetween, second teeth provided between the first teeth adjacent to each other in a circumferential direction of the stator and each having a second counter surface facing the magnet rotor through a second air gap, and drive coils formed by concentrically winding a conductive wire around only the first teeth. A length of the second counter surface is shorter than that of the first counter surface, each of the first and second counter surfaces is a curved surface, the first and second air gaps become larger from the center thereof toward an edge thereof, respectively

### CROSS REFERENCE TO RELATED APPLICATIONS

This application is based on and claims priority under 35 U.S.C. § 119 to Japanese Patent Application 2016-206203, filed on Oct. 20, 2016, the entire contents of which are incorporated herein by reference.

### TECHNICAL FIELD

This disclosure relates to a brushless motor.

### BACKGROUND DISCUSSION

A configuration is generally known in which teeth without a drive coil formed between teeth adjacent to each other in a circumferential direction are arranged in a stator in which a wire is concentrically wound around each of a plurality of teeth radially extending from an inner side of a core back of a stator core in a diameter direction to form a drive coil. According to the configuration, since a width in the circumferential direction of a slot is reduced, a cogging torque can be reduced.

There is a known technology of further reducing a detent torque (cogging torque) by providing a stator which is formed such that a length in a circumferential direction of a tip portion of a tooth in which a drive coil is not formed is shorter than a length in a circumferential direction of a tip portion of a tooth in which a drive coil is formed, in a brushless motor including the stator (for example, Japanese Patent No. 5254203 (reference 1)).

However, if a brushless motor including a stator formed such that a length in a circumferential direction of a tooth in which a drive coil is not formed is shorter than a length in a circumferential direction of a tip portion of a tooth in which the drive coil is formed is driven, a frequency (hereinafter, referred to as a “specific frequency”) with a noise level higher than noise levels of a control frequency and harmonics thereof is generated and noise increases.

Here, the specific frequency is a predetermined frequency included in a non-control frequency. The control frequency is a so-called switching frequency, and is the number of times of switching an on/off combination of switching elements of an inverter circuit per rotation of a magnet rotor. Harmonics of the control frequency are a frequency obtained by multiplying the control frequency by an integer and a frequency obtained by dividing the control frequency by an integer. A non-control frequency is a frequency that does not include the control frequency and harmonics thereof.

Thus, a need exists for a brushless motor which is not susceptible to the drawback mentioned above.

### SUMMARY

A brushless motor according to an aspect of this disclosure includes a magnet rotor that is rotatable integrally with a rotary shaft; and a stator that is disposed to face the magnet rotor with a gap therebetween in a diameter direction of the magnet rotor. The stator includes a plurality of first teeth each having a first counter surface facing the magnet rotor with a first air gap therebetween in the diameter direction, a plurality of second teeth each being provided between the first teeth adjacent to each other in a circumferential direction of the stator and each having a second counter surface facing the magnet rotor through a second air gap in the diameter direction, and drive coils that are formed by concentrically winding a conductive wire around only the first teeth. A length of the second counter surface in the circumferential direction is shorter than a length of the first counter surface in the circumferential direction. Each of the first counter surface and the second counter surface is a curved surface. The first air gap becomes larger from the center of the first air gap in the circumferential direction toward an edge of the first air gap. The second air gap becomes larger from the center of the second air gap in the circumferential direction toward an edge of the second air gap.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a sectional view of a brushless motor according to one embodiment which is taken in a plane in a diameter direction;

FIG. 2 is an enlarged view of a part of a magnet rotor and a stator of FIG. 1;

FIG. 3 is a graph illustrating a relationship between first and second curvature radius ratios and an electromagnetic force between the stator at the time of driving the brushless motor and a permanent magnet;

FIG. 4 is a graph illustrating a relationship between the first and second curvature radius ratios and a constraint torque; and

FIG. 5 is a graph illustrating a relationship between the first and second curvature radius ratios and a cogging torque.

### DETAILED DESCRIPTION

Hereinafter, a brushless motor which is a drive source of a power sliding door device that opens and closes a sliding door provided in a vehicle will be described with reference to the drawings.

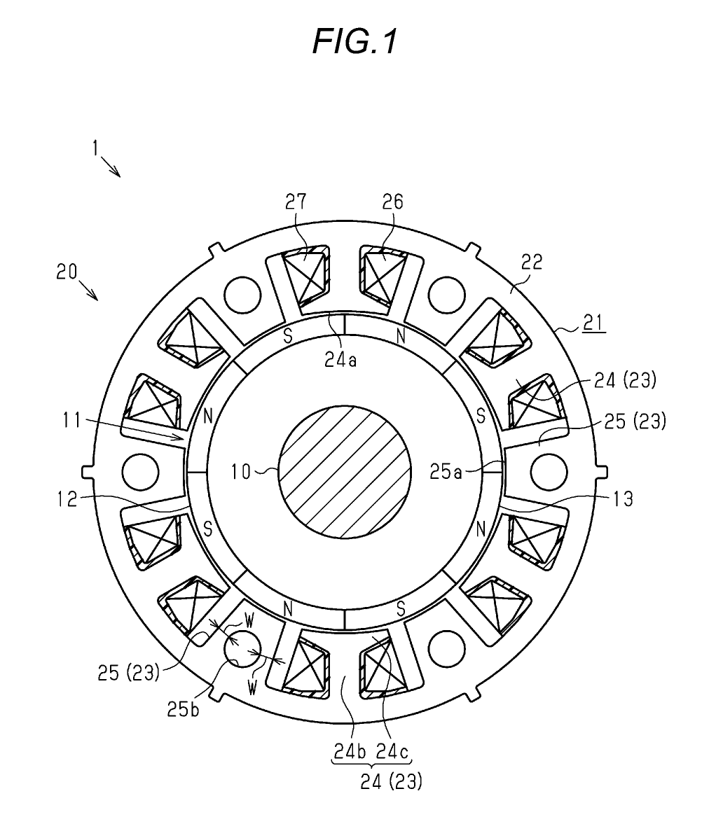

As illustrated in FIG. 1, a brushless motor 1 is a three-phase drive type motor which rotates based on drive power of three phases (U-phase, V-phase, W-phase) supplied by a control device of a vehicle through an inverter circuit (not illustrated together). The inverter circuit includes a U-phase switching arm, a V-phase switching arm, and a W-phase switching arm (not illustrated together). In each switching arm, a pair of switching elements (not illustrated) are connected in series. The inverter circuit supplies U-phase drive power, V-phase drive power, and W-phase drive power to the brushless motor 1 by turning on and off six switching elements. The brushless motor 1 can rotate forwardly and reversely in order to open and close a sliding door.

The brushless motor 1 is an inner rotor type motor in which a magnet rotor 11 that rotates integrally with a rotary shaft 10 is disposed on an inner side of a stator 20 which forms a magnetic field by supplying each drive power. In the following description, an “axial direction” indicates a direction in which the rotary shaft 10 extends, a “diameter direction” indicates a direction orthogonal to the axial direction, and a “circumferential direction” indicates a direction along a direction around a central axis of the rotary shaft 10.

The magnet rotor 11 includes a cylindrical rotor core 12 fixed to the rotary shaft 10. The rotor core 12 is configured by stacking a plurality of magnetic steel plates formed in an annular shape. A permanent magnet 13 of a ring shape is fixed to an outer circumferential surface of the rotor core 12, for example, by an adhesive. In a circumferential direction of the permanent magnet 13, an N pole and a S pole are alternately magnetized in eight poles. The permanent magnet 13 has polar anisotropy. Thereby, magnetic flux density of the permanent magnet 13 changes in a sinusoidal manner in the circumferential direction. Accordingly, it is possible to reduce the cogging torque of the brushless motor 1.

The stator 20 is disposed to face the outer circumferential surface of the magnet rotor 11 through a gap. The stator 20 includes a stator core 21 configuring a magnetic circuit with the permanent magnet 13. The stator core 21 is configured by stacking a plurality of magnetic steel plates in an axial direction. The stator core 21 is configured by an annular core back 22 and a plurality of teeth 23 radially extending from the core back 22 toward the rotary shaft 10. Twelve teeth 23 according to the present embodiment are arranged at equal intervals in a circumferential direction. As such, a relationship between the number of magnetic poles P and the number of slots S of the brushless motor 1 is 8P12S. The number of magnetic poles and the number of slots of the brushless motor 1 are arbitrarily set. For example, the number of magnetic poles and the number of slots of the brushless motor 1 may be 10P12S, 8P6S, and the like. In addition, arrangement of the plurality of teeth 23 is arbitrarily set. For example, the plurality of teeth 23 may be arranged at unequal pitches (unequal intervals) in a circumferential direction.

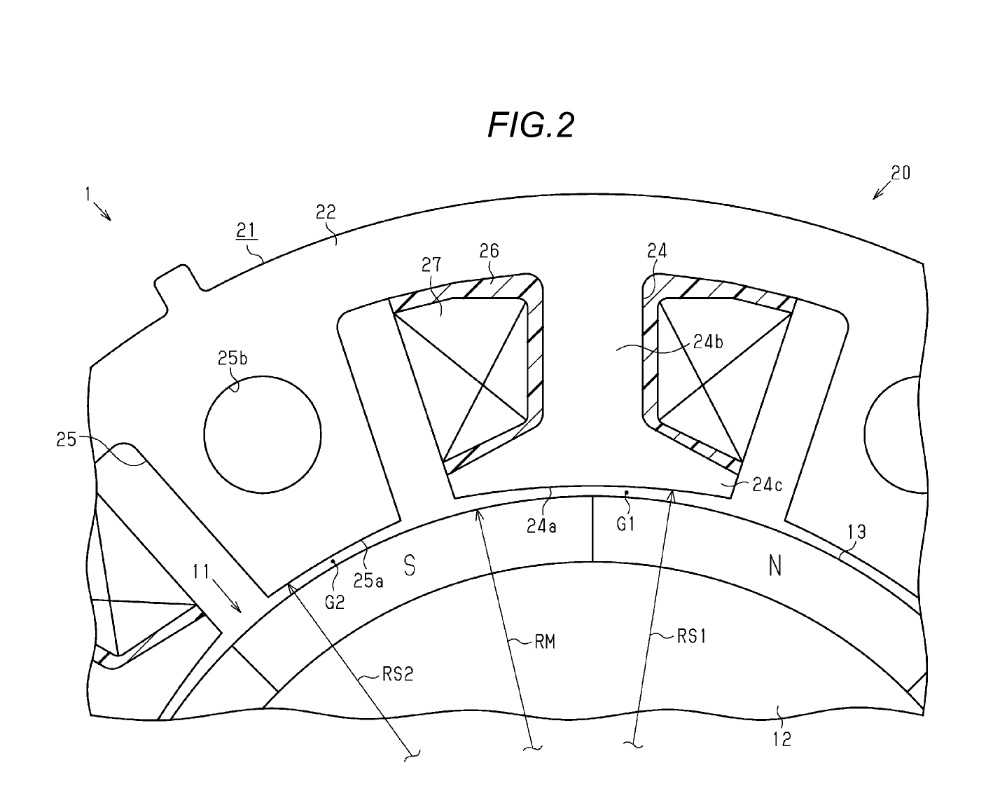

The plurality of teeth 23 include a plurality of first teeth 24 separately arranged in a circumferential direction and a plurality of second teeth 25 arranged between the first teeth 24 adjacent in a circumferential direction. Thereby, the first teeth 24 and the second teeth 25 are alternately arranged in the circumferential direction. As illustrated in FIG. 1, a shape of the first teeth 24 is different from a shape of the second teeth 25. The first teeth 24 are provided with a first counter surface 24a that is an inner circumferential surface of the first teeth 24 facing an outer circumferential surface of the magnet rotor 11 (permanent magnet 13) through a first air gap G1 (refer to FIG. 2) in a diameter direction. The second teeth 25 are provided with a second counter surface 25a that is an inner circumferential surface of the second teeth 25 facing an outer circumferential surface of the magnet rotor 11 (permanent magnet 13) through a second air gap G2 (refer to FIG. 2) in a diameter direction. A length of the second counter surface 25a in the circumferential direction is shorter than a length of the first counter surface 24a in the circumferential direction. Each of the length of the second counter surface 25a in the circumferential direction and the length of the first counter surface 24a in the circumferential direction is set such that a cogging torque of the brushless motor 1 is small enough and a constraint torque is large enough. In the present embodiment, the length of the second counter surface 25a in the circumferential direction is approximately one half of the length of the first counter surface 24a in the circumferential direction.

An insulator 26 formed of a resin with electrical insulation property is attached to the stator core 21. While the insulator 26 covers an inner circumferential surface of the core back 22, side surfaces of the first teeth 24, and both end surfaces (not illustrated) in an axis direction, the insulator does not cover the first counter surface 24a and the second teeth 25.

The stator 20 is formed by winding a conductive wire from above the insulator 26 on the first teeth 24, and has drive coils 27 to which three-phase drive power is supplied. Each of the drive coils 27 is formed by concentrically winding a conductive wire around one first tooth 24. Meanwhile, a conductive wire is not wound around the second tooth 25. As such, the stator 20 is configured such that the teeth 23 (the first teeth 24) in which the drive coil 27 is formed and the teeth 23 (the second teeth 25) in which the drive coil 27 is not formed are alternately arranged in a circumferential direction.

The first tooth 24 includes a coil mounting portion 24b extending on an inner side in a diameter direction from the core back 22. A tip portion 24c configuring the first counter surface 24a is formed at an end portion on an inner side of the first tooth 24 in a diameter direction, that is, a portion on an inner side in a diameter direction more than the coil mounting portion 24b in the first tooth 24. A length of the tip portion 24c in the circumferential direction, that is, a length of the first counter surface 24a in the circumferential direction is larger than a length of the coil mounting portion 24b in the circumferential direction. The length of the coil mounting portion 24b in the circumferential direction is defined by a circumferential length between a side surface on one side in the circumferential direction and a side surface on the other side in the circumferential direction of the coil mounting portion 24b.

The length of the second tooth 25 in the circumferential direction is smaller as the second tooth extends on an inner side in the diameter direction from the core back 22, and becomes minimum on the second counter surface 25a. A through-hole 25b penetrating the second tooth 25 in an axis direction is formed in a portion on an outer portion of the second tooth 25 in a diameter direction. The through-hole 25b can be used as positioning of the stator 20 with respect to housing when the stator 20 is installed in a housing (not illustrated) of the brushless motor 1. In addition, a screw (not illustrated) is inserted into the through-hole 25b to be screwed into the housing, and thereby, the stator 20 can be fixed to the housing. In addition, although the through-hole 25b is formed in the second tooth 25, a magnetic path W other than the through-hole 25b of the second tooth 25 in the portion of the second tooth 25 in which the through-hole 25b is formed is sufficiently secured, and thereby, a magnetic saturation Is less likely to occur in the second tooth 25. As such, since a structure for fixing the stator 20 to the housing is provided in the stator core 21, it is possible to reduce a size of the brushless motor 1 in a diameter direction, compared with a case where a structure for fixing the stator 20 to the housing is provided on an outer side of the stator core 21 in a diameter direction.

As illustrated in FIG. 2, each of the first counter surface 24a and the second counter surface 25a is formed by a curved surface that curves so as to be separated from the rotary shaft 10 (refer to FIG. 1) in a diameter direction, that is, a curved surface that curves on an outer side in the diameter direction. The first counter surface 24a is formed in a circular arc in which the center of the first counter surface 24a in a circumferential direction has the largest curve in a planar view. The second counter surface 25a is formed in a circular arc in which the center of the second counter surface 25a in the circumferential direction has the largest curve in a planar view. A curvature radius RS1 of the first counter surface 24a and a curvature radius RS2 of the second counter surface 25a are equal to each other. The curvature radii RS1 and RS2 are larger than a curvature radius RM of the permanent magnet 13. Accordingly, each of a first curvature radius ratio RX1 (RS1/RM) which is a ratio of the curvature radius RS1 to the curvature radius RM and a second curvature radius ratio RX2 (RS2/RM) which is a ratio of the curvature radius RS2 to the curvature radius RM2 is greater than 1. In the present embodiment, since the curvature radius RS1 and the curvature radius RS2 are equal, the first curvature radius ratio RX1 and the second curvature radius ratio RX2 are equal.

According to the configuration, the first air gap G1 becomes larger from the center of the first counter surface 24a in the circumferential direction toward an edge of the first counter surface 24a in the circumferential direction. In addition, the second air gap G2 becomes larger from the center of the second counter surface 25a in the circumferential direction toward an edge of the second counter surface 25a in the circumferential direction.

As described above, a sudden change in an electromagnetic force ME between the permanent magnet 13 and the stator core 21 according to rotation of the magnet rotor 11, that is, a sudden change of a force applied to the stator 20 can be suppressed by the first air gap G1 and the second air gap G2. Thereby, vibration of the stator 20 caused by the electromagnetic force ME is reduced, and thus, it is possible to reduce noise of the brushless motor 1. In particular, the brushless motor 1 serves as a drive source of a power sliding door device provided in a body side portion close to a passenger compartment, and thus, it is possible to reduce discomfort of a passenger due to noise of the brushless motor 1.

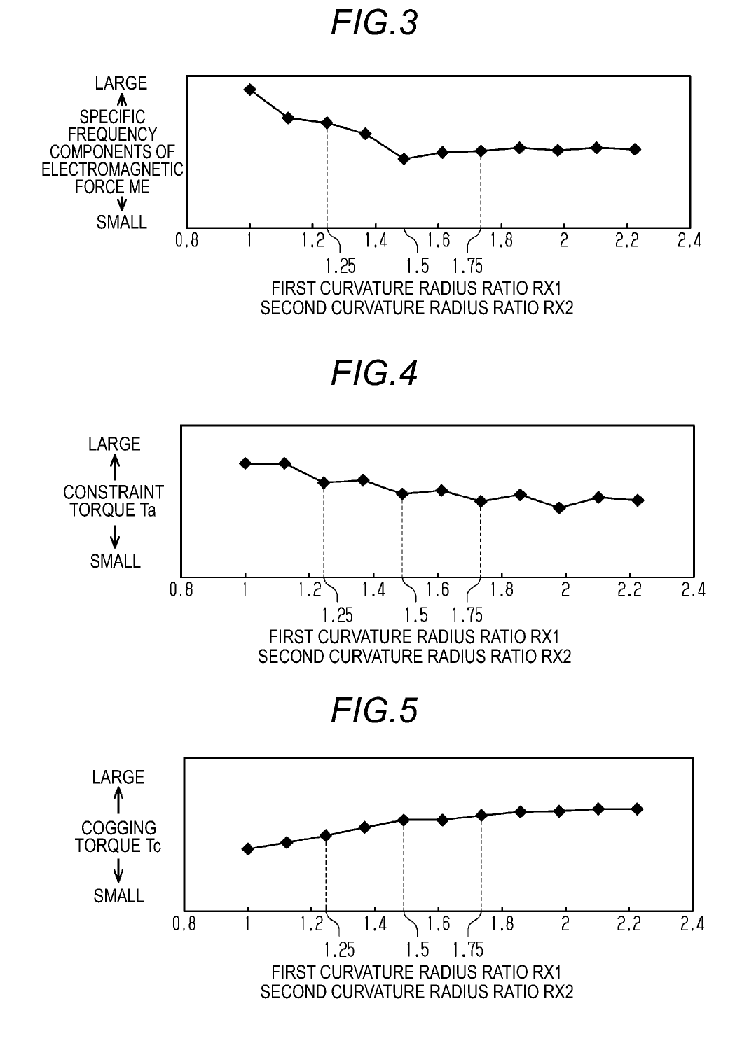

Next, in order to obtain an appropriate size of the first air gap G1 and the second air gap G2, test results for confirming a relationship between sizes of the first air gap G1 and the second air gap G2 and the electromagnetic force ME will be described. FIG. 3 illustrates an example of test results illustrating a relationship between the first curvature radius ratio RX1 and the second curvature radius ratio RX2 which define the first air gap G1 and the second air gap G2 and the specific frequency component of the electromagnetic force ME. The following can be confirmed from the test results. In a case where each of the first curvature radius ratio RX1 and the second curvature radius ratio RX2 is larger than 1, the specific frequency components of the electromagnetic force ME are reduced. In a case where each of the first curvature radius ratio RX1 and the second curvature radius ratio RX2 is included in a range larger than or equal to 1.25 and smaller than or equal to 1.75, the specific frequency components of the electromagnetic force ME is further reduced. In addition, reduction of the specific frequency different from the control frequency (24th order frequency) of the brushless motor 1 is confirmed.

In addition, it is known that a constraint torque Ta or a cogging torque Tc are affected by changes of the first air gap G1 and the second air gap G2 in size. FIG. 4 is an example of test results illustrating a relationship between the first and second curvature radius ratios RX1 and RX2 and the constraint torque Ta. FIG. 5 is an example of test results illustrating a relationship between the first and second curvature radius ratio RX1 and RX2 and the cogging torque Tc. From the test results in FIGS. 4 and 5, the following can be confirmed. As illustrated in FIG. 4, as each of the first curvature radius ratio RX1 and the second curvature radius ratio RX2 increases in a range in which each of the first curvature radius ratio RX1 and the second curvature radius ratio RX2 is larger than or equal to 1, the constraint torque Ta decreases. As illustrated in FIG. 5, as each of the first curvature radius ratio RX1 and the second curvature radius ratio RX2 increases in a range in which each of the first curvature radius ratio RX1 and the second curvature radius ratio RX2 is larger than or equal to 1, the cogging torque Tc increases.

It is preferable that each of the first curvature radius ratio RX1 and the second curvature radius ratio RX2 is larger than 1 from the test results illustrated in FIGS. 3 to 5. Thereby, the cogging torque Tc increases more compared with a case where each of the first curvature radius ratio RX1 and the second curvature radius ratio RX2 is 1, but the specific frequency components of the electromagnetic force ME can be reduced, and thus, it is possible to reduce a noise level of the entire brushless motor 1. In addition, the constraint torque Ta can be prevented from becoming too small as compared with a case where each of the first curvature radius ratio RX1 and the second curvature radius ratio RX2 is 1. Thus, when performance of the brushless motor is totally viewed, the performance of the brushless motor 1 increases more than performance of a comparative motor.

It is more preferable that each of the first curvature radius ratio RX1 and the second curvature radius ratio RX2 is larger than or equal to 1.25 and smaller than or equal to 1.75. Thereby, the specific frequency components of the electromagnetic force ME can be reduced and the cogging torque Tc can be reduced as compared with a case where each of the first curvature radius ratio RX1 and the second curvature radius ratio RX2 is larger than 1 and less than 1.25. Thus, it is possible to reduce the noise level of the entire brushless motor 1. In addition, the constraint torque Ta can increase and the cogging torque Tc can be reduced as compared with a case where each of the first curvature radius ratio RX1 and the second curvature radius ratio RX2 is larger than 1.75. Thus, it is possible to further increase the performance of the brushless motor 1.

It is most preferable that each of the first curvature radius ratio RX1 and the second curvature radius ratio RX2 is 1.5. Thereby, the most specific frequency components of the electromagnetic force ME can be reduced and the cogging torque Tc can be reduced as compared with a case where each of the first curvature radius ratio RX1 and the second curvature radius ratio RX2 is larger than 1.5 and smaller than or equal to 1.75. Thus, it is possible to reduce the noise level of the brushless motor 1. In addition, the constraint torque Ta can increase as compared with a case where each of the first curvature radius ratio RX1 and the second curvature radius ratio RX2 is larger than 1.5 and smaller than or equal to 1.75. Thus, it is possible to further increase the performance of the brushless motor 1. Each of the first curvature radius ratio RX1 and the second curvature radius ratio RX2 according to the present embodiment is 1.5.

The aforementioned embodiment may be modified as follows.

In the aforementioned embodiment, each of the first curvature radius ratio RX1 and the second curvature radius ratio RX2 may be arbitrarily set. For example, the first curvature radius ratio RX1 and the second curvature radius ratio RX2 may be different from each other.

In the aforementioned embodiment, a structure is provided in which the stator 20 is fixed to a housing by the through-hole 25b of the second tooth 25, but the present disclosure is not limited to this, the through-hole 25b may be omitted from the second tooth 25, and a structure for fixing the stator 20 to the housing may be provided on an outer side more than the stator 20 in the diameter direction.

Although the annular core back 22 and the plurality of teeth 23 extending on an inner side in the diameter direction from the core back 22 are integrally formed in the aforementioned embodiment, the present disclosure is not limited to this, and the stator core 21 may be a curling core or a split core.

In the aforementioned embodiment, the permanent magnet 13 has polar anisotropy, but the present disclosure is not limited to this, and, for example, the permanent magnet 13 may have radial anisotropy. In this case, while the constraint torque Ta increases, the cogging torque Tc also increases. In addition, the permanent magnet 13 may have isotropy.

In the aforementioned embodiment, the permanent magnet 13 is formed in a ring shape, but the present disclosure is not limited to this, and the permanent magnet may be a so-called segment magnet configured by a plurality of permanent magnets.

In the aforementioned embodiment, a surface magnet structure is provided in which the permanent magnet 13 is fixed to the outer circumferential surface of the rotor core 12, but the present disclosure is not limited to this, and an embedded magnet structure in which the permanent magnet 13 is contained in a portion on an inner side in a diameter direction more than an outer circumferential surface of the rotor core 12 may be provided in the rotor core 12. In a case of the embedded magnet structure, the outer circumferential surface of the rotor core 12 corresponds to an outer circumferential surface of the magnet rotor 11. In addition, the permanent magnet 13 may be integrally formed with the rotary shaft 10 by using a resin without using the rotor core 12.

In the aforementioned embodiment, the brushless motor 1 is an inner rotor type, but the present disclosure is not limited to this, and the brushless motor 1 may be an outer rotor type in which the magnet rotor 11 having the permanent magnet 13 is disposed on an outer side of the stator 20 in a diameter direction. In this case, for example, a curvature radius of an inner circumferential surface of the permanent magnet 13 is smaller than a curvature radius of the first counter surface 24a which is an outer circumferential surface of the first tooth 24 and a curvature radius of the second counter surface 25a which is an outer circumferential surface of the second tooth 25. Thereby, the first air gap G1 between the first counter surface 24a and the outer circumferential surface of the magnet rotor 11 gradually increases from the center of the first air gap G1 in a circumferential direction toward an edge of the first air gap G1. In addition, the second air gap G2 between the second counter surface 25a and the outer circumferential surface of the magnet rotor 11 gradually increases from the center of the second air gap G2 in a circumferential direction toward an edge of the second air gap G2.

In the aforementioned embodiment, the brushless motor is applied to a drive source of a power sliding door device, but the present disclosure is not limited to this, and, for example, the brushless motor may be applied to a drive source for a back door, a luggage door, or a trunk lid provided at a rear portion of a vehicle, or a drive source for a power window.

A brushless motor according to an aspect of this disclosure includes a magnet rotor that is rotatable integrally with a rotary shaft; and a stator that is disposed to face the magnet rotor with a gap therebetween in a diameter direction of the magnet rotor. The stator includes a plurality of first teeth each having a first counter surface facing the magnet rotor with a first air gap therebetween in the diameter direction, a plurality of second teeth each being provided between the first teeth adjacent to each other in a circumferential direction of the stator and each having a second counter surface facing the magnet rotor through a second air gap in the diameter direction, and drive coils that are formed by concentrically winding a conductive wire around only the first teeth. A length of the second counter surface in the circumferential direction is shorter than a length of the first counter surface in the circumferential direction. Each of the first counter surface and the second counter surface is a curved surface. The first air gap becomes larger from the center of the first air gap in the circumferential direction toward an edge of the first air gap. The second air gap becomes larger from the center of the second air gap in the circumferential direction toward an edge of the second air gap.

According to this configuration, a noise level of a specific frequency is reduced by increasing a first air gap and a second air gap from the center toward an edge in a circumferential direction of the stator. Accordingly, it is possible to reduce noise of the brushless motor.

In the brushless motor, it is preferable that the brushless motor is a brushless motor of an inner rotor type, each of the first counter surface and the second counter surface is a curved surface that is curved so as to be separated from the rotary shaft in the diameter direction, and each of a first curvature radius ratio that is a ratio of a curvature radius of the first counter surface to a curvature radius of an outer circumferential surface of the magnet rotor and a second curvature radius ratio that is a ratio of a curvature radius of the second counter surface to the curvature radius of the outer circumferential surface of the magnet rotor is larger than 1.

According to this configuration, by making each of a first curvature radius ratio and a second curvature radius ratio larger than 1, it is possible to easily realize a structure in which each of a first air gap and a second air gap becomes larger from the center toward an edge in a circumferential direction of the stator.

In the brushless motor, it is preferable that the first curvature radius ratio and the second curvature radius ratio are equal to each other, are larger than or equal to 1.25, and are smaller than or equal to 1.75.

According to this configuration, while a noise level of a specific frequency is further reduced, it is possible to further prevent the constraint torque from becoming excessively small and to further prevent the cogging torque from becoming excessively large. Thus, it is possible to further increase performance of the brushless motor.

In the brushless motor, it is preferable that each of the first curvature radius ratio and the second curvature radius ratio is 1.5.

According to this configuration, while a noise level of a specific frequency is further reduced, it is possible to further prevent a constraint torque from becoming excessively small and to further prevent the cogging torque from becoming excessively large. Thus, it is possible to further increase performance of the brushless motor.

In the brushless motor, it is preferable that the magnet rotor has polar anisotropy.

According to the configuration, it is possible to reduce a cogging torque.

According to the brushless motor, it is possible to reduce noise.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A brushless motor comprising:
a magnet rotor that is rotatable integrally with a rotary shaft; and
a stator that is disposed to face the magnet rotor with a gap therebetween in a diameter direction of the magnet rotor,
wherein the stator includes
a plurality of first teeth each having a first counter surface facing the magnet rotor with a first air gap therebetween in the diameter direction,
a plurality of second teeth each being provided between the first teeth adjacent to each other in a circumferential direction of the stator and each having a second counter surface facing the magnet rotor through a second air gap in the diameter direction, and
drive coils that are formed by concentrically winding a conductive wire around only the first teeth,
a length of the second counter surface in the circumferential direction is shorter than a length of the first counter surface in the circumferential direction,
each of the first counter surface and the second counter surface is a curved surface,
the first air gap becomes larger from the center of the first air gap in the circumferential direction toward an edge of the first air gap, and
the second air gap becomes larger from the center of the second air gap in the circumferential direction toward an edge of the second air gap.

2. The brushless motor according to claim 1,
wherein the brushless motor is a brushless motor of an inner rotor type,
each of the first counter surface and the second counter surface is a curved surface that is curved so as to be separated from the rotary shaft in the diameter direction, and
each of a first curvature radius ratio that is a ratio of a curvature radius of the first counter surface to a curvature radius of an outer circumferential surface of the magnet rotor and a second curvature radius ratio that is a ratio of a curvature radius of the second counter surface to the curvature radius of the outer circumferential surface of the magnet rotor is larger than 1.

3. The brushless motor according to claim 2,
wherein the first curvature radius ratio and the second curvature radius ratio are equal to each other, are larger than or equal to 1.25, and are smaller than or equal to 1.75.

4. The brushless motor according to claim 3,
wherein each of the first curvature radius ratio and the second curvature radius ratio is 1.5.

5. The brushless motor according to claim 1,
wherein the magnet rotor has polar anisotropy.
